(19) United States
(12) Patent Application Publication
(10) Pub. No.: US 2017/0258016 A1
(43) Pub. Date: Sep. 14, 2017

(54) LENGTH-AND-SHAPE CUSTOMIZABLE PLANTER

(71) Applicants: Ezer GOSHEN, OR-YEHUDA (IL); Ron HAREL, TEL AVIV (IL); Ran BEN OR, LAPID (IL)

(72) Inventors: Ezer GOSHEN, OR-YEHUDA (IL); Ron HAREL, TEL AVIV (IL); Ran BEN OR, LAPID (IL)

(21) Appl. No.: 15/310,183

(22) PCT Filed: May 7, 2015
(86) PCT No.: PCT/IL2015/050477

§ 371 Date: Nov. 10, 2016

Related U.S. Application Data
(60) Provisional application No. 61/991,639, filed on May 12, 2014.

(51) Int. Cl. A01G 9/02; A01C 23/00; A01G 27/00

(52) U.S. Cl. CPC A01G 9/027; A01G 27/003; A01C 23/00; A01G 27/00

(57) ABSTRACT

A set for assembling a length and shape adjustable planter comprising (a) a plurality of elongate troughs being length customizable by cutting thereof; the elongate troughs having a longitudinal axis and a H-inverted cross section; the elongate troughs interconnectable therebetween; (b) interconnecting members configured for interconnecting the elongate troughs in series; and (c) end members configured for mounting onto a free end of the elongate troughs. A surface of each trough at least partially is provided with a surface profile distributed over a length of the trough. The interconnecting members are securable on the surface profile.

### FIELD OF THE INVENTION

The present invention generally relates to planting receptacles and more specifically to a set for assembling a length and shape adjustable planter and a method of implementing the same.

### BACKGROUND OF THE INVENTION

A planter is usually placed outdoors and/or indoors and used for displaying live plants and flowers, but it may also be used for growing herbs or other edible plants. Window boxes are used to decorate for the different seasons as well. In the planters, any flowers and vegetables can be grown.

U.S. Pat. No. 4,255,898 discloses a channel culture device for plant systems which comprising a plurality of longitudinal growing channels, for growing the primary plants, and service channels, which aid the growing channels. The channels alternate and fluids, water and air, pass laterally between the growing and service channels which enhance plant growth.

U.S. Pat. No. 4,420,902 discloses a modular planting apparatus including a plurality of tubular modules having access slots in the tops of the side walls and connectors for joining adjacent modules.

U.S. Pat. No. 5,852,895 discloses planter assembly comprising a planter box and a support structure for the planter box. The support structure is formed by an elevating post, a base beneath the post and a planter box support atop the post. The post is releasably secured within the support structure which enables height adjustment trimming and then refitting of the post with the support structure.

U.S. Pat. No. 5,996,280 discloses a modular soil conserving planter constituting a longitudinal trough having open transverse end faces, the trough including a lower horizontal grate and an upper horizontal grate, each of such grates extending along substantially the longitudinal length of the trough, the lower grate defining a drainage grate and the upper grate defining a soil retention grate, a region of the trough beneath the drainage grate including apertures for control of drainage from the trough, in which longitudinal ends of the trough. Each longitudinal end of the trough further includes means for selectable connections to open end faces of adjoining like planters.

U.S. Pat. No. 6,837,002 discloses a modular type tray for hydroponic and aeroponic cultivation, in which the nutritive solution is carried to the roots of plants grown in the tray by a tube with built-in drips situated in a slot on the tray bottom. The tray consists of at least one plastic casing made by extrusion, a pair of closing flanges to be fixed to the opposite tray ends and (if necessary) at least one middle flange, placed between two plastic casings to join them together with a watertight seal.

U.S. Pat. No. 6,986,222 discloses a planting assembly including a flexible trough member which may selectively form a plurality of members which may be then selectively interconnected in any desired manner.

U.S. Pat. No. 7,306,402 discloses landscaping channel liner apparatus having a longitudinally-extending trough and longitudinally-extending receptacles. The longitudinally-extending trough has a longitudinally-extending floor located between opposed longitudinally-extending side walls extending therefrom. The longitudinally-extending trough also has first and second opposed transverse open ends formed from the floor and side walls. Each of the side walls defines a longitudinally-extending edge located opposite the longitudinally-extending floor. A longitudinally-extending receptacle is located on each longitudinally-extending edge and includes first and second transverse open ends.

Technical analysis of the prior art indicates market presence of modular planters. The known modules can be configured into the planters of discrete length and shape. A long-felt and unmet problem to be solved by the present invention is to provide a set for assembling a planter allowing fine length and shape and/or size adjustment. The lateral size, contrary to the length, should provide unified connectability and changeability.

### SUMMARY OF THE INVENTION

It is hence one object of the invention to disclose a set for assembling a length and shape adjustable planter. The aforesaid set comprises (a) plurality of elongate troughs being length customizable by cutting thereof; the elongate troughs having a longitudinal axis and a H-inverted cross section; the elongate troughs interconnectable therebetween; and (b) interconnecting members configured for interconnecting the elongate troughs in series.

It is a core purpose of the invention to provide a surface of each trough at least partially is provided with a surface profile distributed over a length of the trough. The interconnecting members are securable on the surface profile.

Another object of the invention is to disclose said troughs of the plurality configured in a shape selected from a group consisting of a H-inverted profile with open ends, a H-inverted profile with closed ends, a H-inverted profile having open and closed ends and any combination thereof.

A further object of the invention is to disclose the set comprising end members configured for mounting onto a free end of said elongate troughs.

A further object of the invention is to disclose the surface profile selected from the group consisting of a polygon surface profile, a sinusoidal profile and a comb-like profile including a skewed comb-like surface profile.

A further object of the invention is to disclose the polygon profile selected from the group consisting of a rectangular surface profile and a triangular surface profile including a saw-tooth surface profile.

A further object of the invention is to disclose the surface profile is formed by ribs projecting into an internal space of the trough. Each of the interconnecting and end members has a comb-like structure conformably configured for receiving the projecting ribs to be secured on the end fixating structures.

A further object of the invention is to disclose the set comprising a plurality of two-side comb fitting pieces placeable between the ribs and the interconnecting or end members having comb-like structure on opposite sides thereof.

A further object of the invention is to disclose a lower side of said double-side comb fitting piece which is partially secured to said ribs located at a first elongated trough to be interconnected and partially secured to said ribs located at a second elongated trough to be interconnected.

A further object of the invention is to disclose the set comprising a plurality of edge stoppers configured for inserting into the second comb-like structure of the double-comb fitting piece secured to the end structure of the elongated trough to prevent trough content from pouring out during conveying or assembling.

A further object of the invention is to disclose the set comprising at least one articulation member configured for interconnecting the elongate troughs at a customizable angle.

A further object of the invention is to disclose the articulation member comprising end surface profile structures for connecting to said troughs and a central portion made of a flexible material.

A further object of the invention is to disclose the flexible material selected from the group consisting of a polymer film, a metal foil, a woven fabric, a non-woven fabric and any combination thereof.

A further object of the invention is to disclose the end members configured for inserting the end members into the double-comb fitting pieces secured to the fixating structures.

A further object of the invention is to disclose the set comprising a water-collecting sump which is length customizable by cutting thereof.

A further object of the invention is to disclose the sump provided with at least one reinforcement rib.

A further object of the invention is to disclose the planter trough provided with a water-collecting sump as an integral portion thereof. A further object of the invention is to disclose the planter having an internal shell and an outer shell made from a sheet material by mean of bending thereof. A further object of the invention is to disclose the outer shell provided with at least one cut for evaporation of the water collected in a lower portion of the outer shell.

A further object of the invention is to disclose the trough comprising a water pipe connectable to an irrigation device preprogrammed for feeding water/fertilizer solutions to plants to be contained within the troughs.

A further object of the invention is to disclose the water pipe having openings for dispensing the water/fertilizer solutions into the troughs.

A further object of the invention is to disclose at least one interconnecting member comprising a surface connectable to a vertical wall of interest such that said troughs supported by said interconnecting members are suspendable on said wall.

A further object of the invention is to disclose at least one supporting member comprises a hook for suspending said troughs on a rail.

A further object of the invention is to disclose a method of assembling a length and shape adjustable planter. The aforesaid method comprising the steps of (a) providing a the set comprising (i) a plurality of elongate troughs being length customizable by cutting thereof; the elongate troughs having a longitudinal axis and a H-inverted cross section; the elongate troughs interconnectable therebetween; and (ii) interconnecting members configured for interconnecting the elongate troughs in series; a surface of each trough at least partially is provided with a surface profile perpendicularly oriented to the longitudinal axis; the surface profile are distributed over a length of the trough; the interconnecting members are securable on the surface profile; (b) customizing the length of the troughs by cutting thereof; (c) interconnecting the elongate troughs in series by means the interconnecting members; (d) mounting the end members onto the free ends of the elongate troughs.

It is another core purpose of the invention to provide the step of interconnecting the elongate troughs further comprising securing the interconnecting members on the surface profile.

A further object of the invention is to disclose the step of securing the interconnecting members performed on the surface profile formed by ribs projecting into an internal space of the trough. Each of the interconnecting and end members has a comb-like structure conformably configured for receiving the projecting ribs to be secured on the end fixating structures.

A further object of the invention is to disclose the method comprising a step of placing a plurality of two-side comb fitting pieces between the ribs and the interconnecting or end members having comb-like structure on opposite sides thereof.

A further object of the invention is to disclose the step of placing a plurality of two-side comb fitting pieces comprising securing a lower side of a first double-side comb fitting piece to the ribs located at an portion of a first elongated trough to be interconnected, a lower side of a second double-comb fitting piece to ribs located at an portion of a second elongated trough to be interconnected. The comb-like structure of the interconnecting member is partially received by of an upper side of the first double-side comb fitting piece and partially received by of an upper side of the second double-side comb fitting piece forming a trough interconnection arrangement.

A further object of the invention is to disclose the method comprising a step of inserting a plurality of edge stoppers configured into the upper side of the double-side comb fitting piece secured to the end structure of the elongated trough to prevent trough content from pouring out during conveying or assembling.

A further object of the invention is to disclose the method comprising a step of interconnecting the elongate troughs by means of at least one articulation member at a predetermined angle.

A further object of the invention is to disclose the method comprising a step of irrigating said trough by means of a water pipe connectable to an irrigation device preprogrammed for feeding water/fertilizer solutions to plants to be contained within said troughs.

A further object of the invention is to disclose the step of irrigating the trough performed by means of a water pipe having openings for dispensing the water/fertilizer solutions into the troughs.

A further object of the invention is to disclose the set comprising a step of suspending said troughs on a wall of interest by at least one interconnecting member comprising a surface connectable to a vertical wall of interest such that said troughs supported by said interconnecting members are suspendable on said wall.

A further object of the invention is to disclose a step of suspending said troughs by means of at least one supporting member comprises a hook for suspending said troughs on a rail.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIGS. 1, 2A and 2B are perspective views of rectangular-profile trough, end member and interconnecting member, respectively;

FIGS. 3 and 4 are perspective views of rectangular-profile modular planter in disassembled and assembled positions, respectively;

FIGS. 5, 6A and 6B are perspective views of triangular-profile trough, end member and interconnecting member, respectively;

FIGS. 7 and 8 are perspective views of triangular-profile modular planter in disassembled and assembled positions, respectively

FIG. 9 is a general perspective view of a ribbed planter through;

FIG. 10 is an enlarged perspective view of a ribbed planter through;

FIG. 11 is a perspective view of a ribbed end member;

FIG. 12 is a perspective view of a ribbed planter trough provided with the ribbed end member mounted therewithin;

FIG. 13 is a cross sectional view of the end cap secured to a rib structure;

FIG. 14 is a perspective view of a ribbed interconnecting member;

FIGS. 15 and 16 are a perspective view of a ribbed planter though provided with the ribbed end caps and the ribbed fitting member in disassembled and assembled positions, respectively;

FIG. 17 is a perspective view of a ribbed articulation member;

FIG. 18 is a perspective view of a ribbed interconnection member;

FIGS. 19 and 20 are perspective views of a ribbed articulation member with a ribbed interconnecting member planter in disassembled and assembled positions, respectively;

FIGS. 21 and 22 are perspective views of a ribbed articulation member interconnecting the planter troughs in disassembled and assembled positions, respectively;

FIG. 23 is a general perspective view ribbed articulation member interconnecting the planter troughs;

FIG. 24 is a perspective view of a triangular-profile articulation member;

FIGS. 25 and 26 are perspective views of a triangular-profile articulation member interconnecting the planter troughs in disassembled and assembled positions, respectively;

FIG. 27 is a perspective view of a rectangular-profile articulation member;

FIGS. 28 and 29 are perspective views of a rectangular-profile articulation member interconnecting the planter troughs in disassembled and assembled positions, respectively;

FIG. 30 is a perspective view of an edge stopper;

FIG. 31 is a perspective view of two ribbed planter troughs provided with the edge stoppers mounted therewithin;

FIGS. 32 and 33 are perspective view of two ribbed planter troughs provided with the ribbed interconnecting member mounted therewithin in exploded and assembled positions, respectively;

FIG. 34 is a perspective view of a planter trough provided with a water-collecting sump;

FIG. 35 is an enlarged perspective view of the water-collecting sump;

FIG. 36 is a perspective view of an exemplary length and shape customized planter;

FIG. 37 is a perspective view of an integral planter trough;

FIGS. 38 and 39 are top and bottom perspective views of a closed planter trough;

FIG. 40 is a perspective view of a closed planter trough provided with an irrigation pipe;

FIGS. 41A and 41B are top and bottom perspective views of a corner articulating member;

FIGS. 42A and 42B are top and bottom perspective views of a straight interconnecting member;

FIG. 43A is a perspective view of two closed planter troughs interconnected by an interconnecting member;

FIG. 43B is a perspective view of an exemplar planter configuration including two closed and a corner articulation member interconnected by interconnecting members;

FIGS. 44A and 44B are perspective views of supporting arms connectable to a wall and a rail, respectively;

FIG. 45 is a perspective view of a closed planter trough supported by supporting arms;

FIGS. 46A and 46B are perspective views of a straight water-collecting sump per se and a straight closed trough thereon; and

FIGS. 47A and 47B are perspective views of a corner water-collecting sump per se and corner articulation member thereon.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a set for assembling a length and shape adjustable planter and a method of implementing the same.

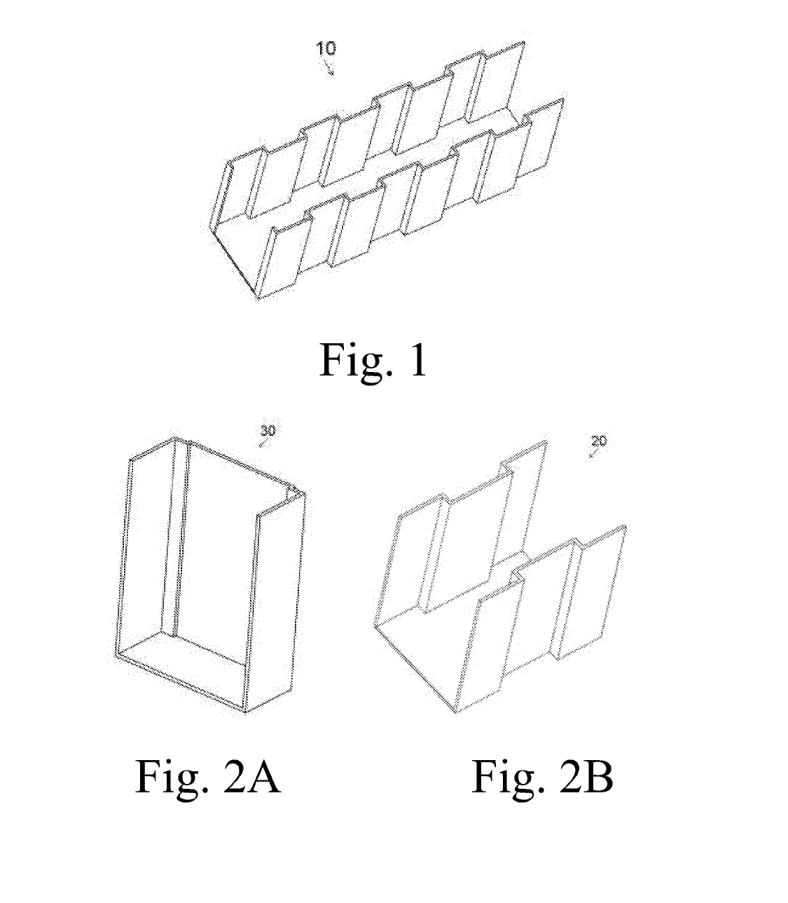

Reference is now made to FIGS. 1, 2A and 2B presenting a planter trough 10, an end member 30 and an interconnecting member 20, respectively. The aforesaid articles 10, 20 and 30 are characterized by a rectangular profile.

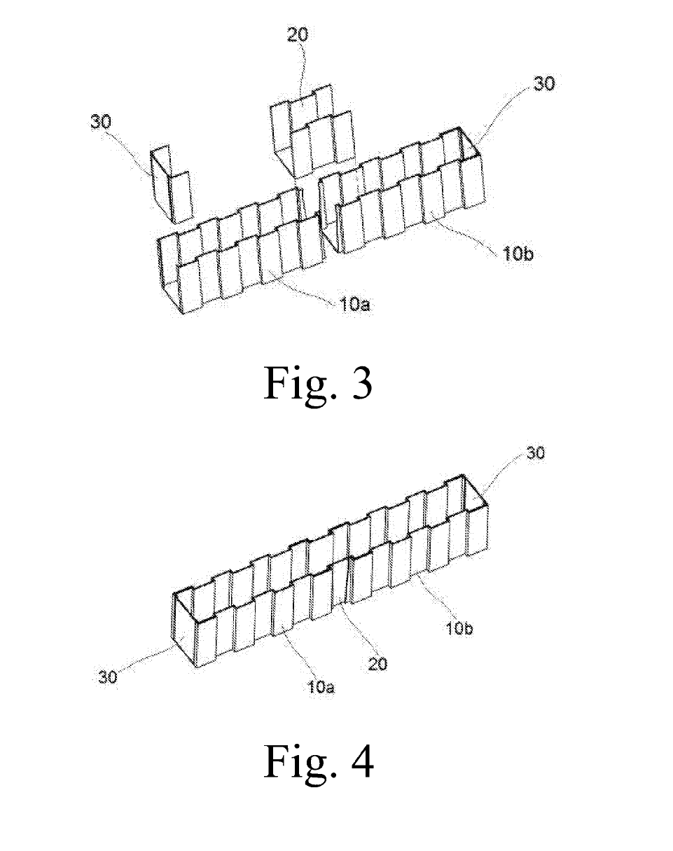

Reference is now made to FIGS. 3 and 4, show the set for assembling a length and shape adjustable planter in disassembled and assembled positions. Specifically, the troughs 10A and 10B can be interconnected by interconnecting members 20. Open ends of the troughs 10A and 10B can be closed by end members 30. According to the present invention, the troughs 10, interconnecting members 20 and end members 30 are characterized by a congruent rectangular surface profile such that interconnecting members 20 and the end members 30 can be inserted into the troughs 10 or vice versa. As seen in FIG. 3, the interconnecting member 20 is partially inserted into a first trough 10A and partially into a second trough 10B such that these first and second troughs 10A and 10B are reliably interconnected. Analogously, end members 30 are inserted into the congruent profile at trough terminals.

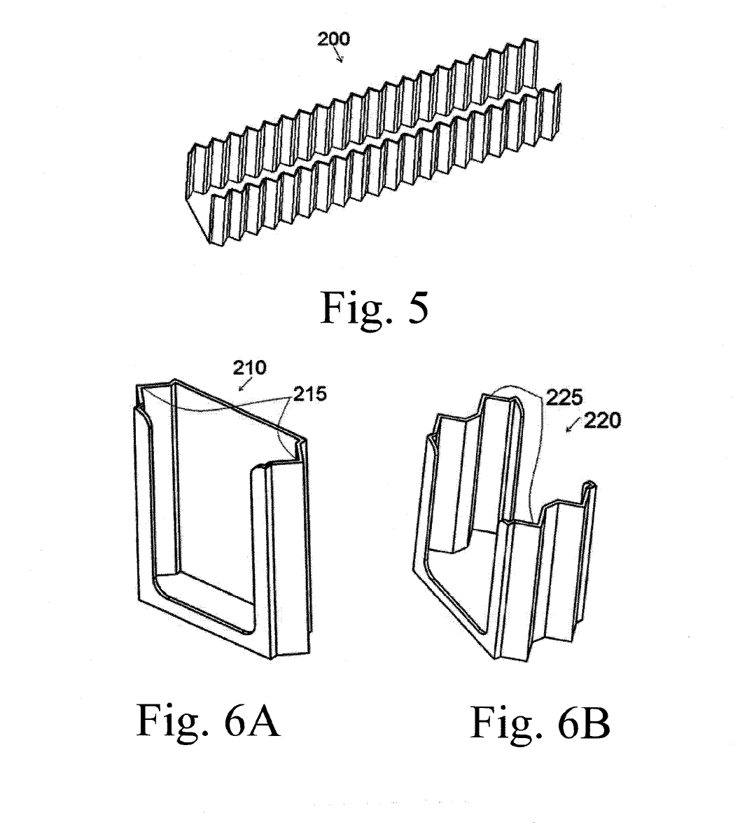

Reference is now made to FIGS. 5, 6A and 6Bb presenting a planter trough 200, an end member 210 and an interconnecting member 220, respectively. The aforesaid articles 200, 210 and 220 are characterized by a triangular profile. The end member 210 and the interconnecting member 220 have side triangular surface profile structures which are conformable to triangular surface profile of the planter trough 200.

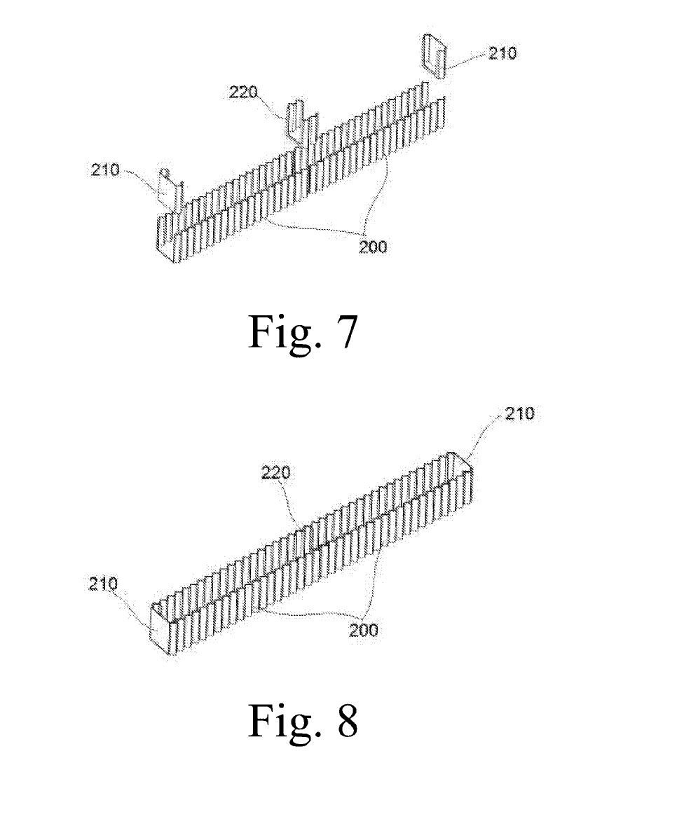

Reference is now made to FIGS. 7 and 8, show the set for assembling a length and shape adjustable planter of triangular surface profile in disassembled and assembled positions. Specifically, troughs 200 can be interconnected by interconnecting members 220. Open ends of the troughs 200 can be closed by end members 210. As seen in FIG. 8, the interconnecting member 220 is partially inserted into one trough 200 and partially into another trough 200 such that a pair of the troughs 200 is interconnected. The end members 210 are inserted into the congruent profile at trough terminals.

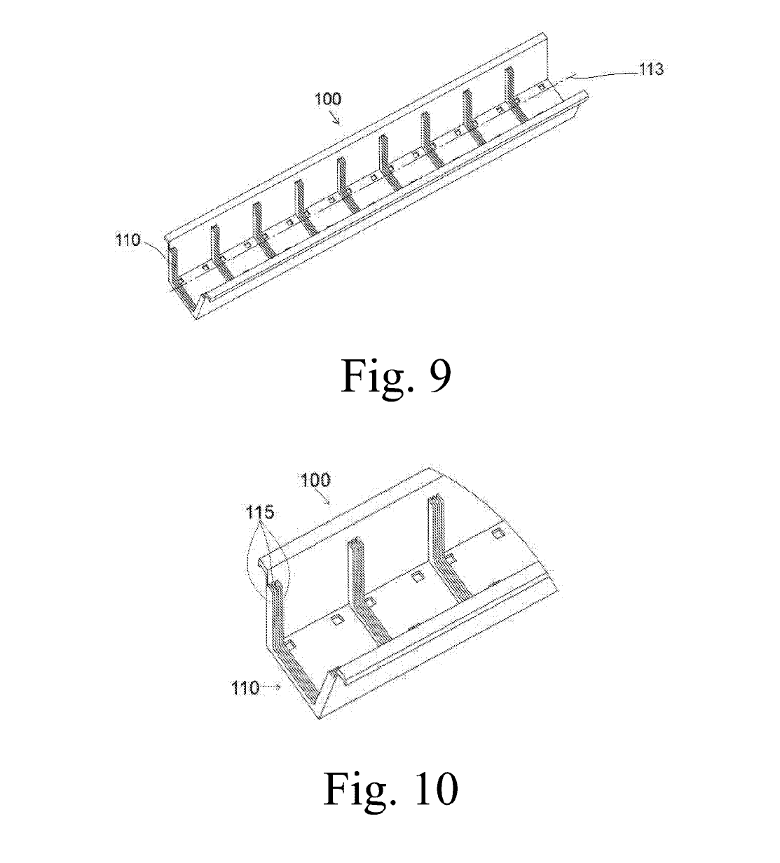

Reference is now made to FIGS. 9 and 10, presenting general and enlarged prospective views of the planter troughs 100. According to one embodiment of the present invention, the surface profile is formed by rib structures 110 distributed of an internal surface of the trough 100. In accordance with a non-limiting exemplar embodiment, the ribs 115 forming the structures 110 are in planes perpendicular to a longitudinal axis 113 of the trough 100. The angled ribs 115 are also in the scope of the present invention.

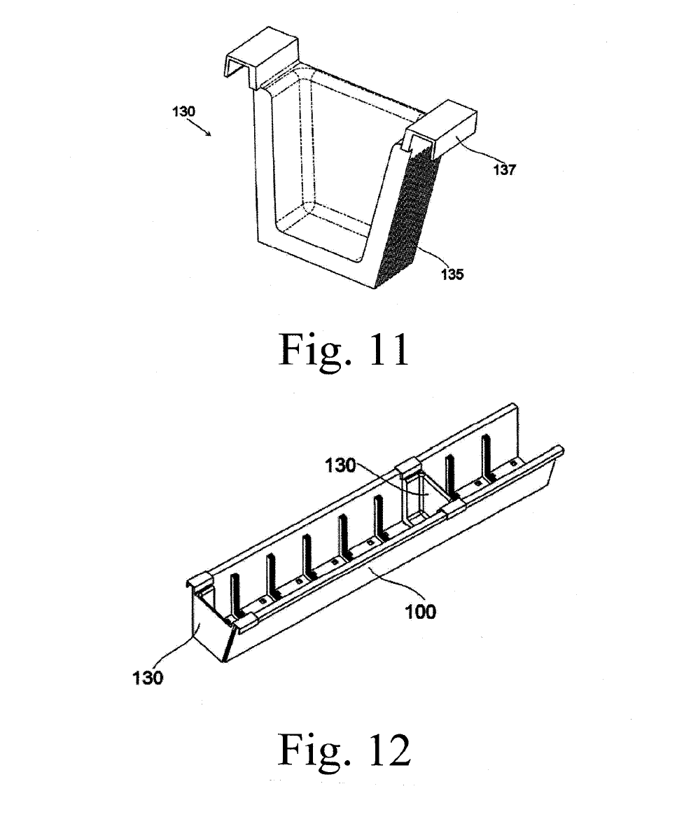

Reference is now made to FIGS. 11 and 12 presenting perspective views of an end member 130 and planter through 100 provided with the end member 130 mounted therewithin. The end member 130 is provided with a comb-like structure 135 conformably configured for receiving the projecting ribs 115 or to be secured on the end fixating structures. Grips 137 serve for additional mechanical securing the end member 130 on the trough 100. As seen FIG. 12, the end members 130 are mounted into the trough 100. It should be appreciated that comb-like structure allows securing the end member 130 precisely. A pitch of end member mounting is defined by comb spacing.

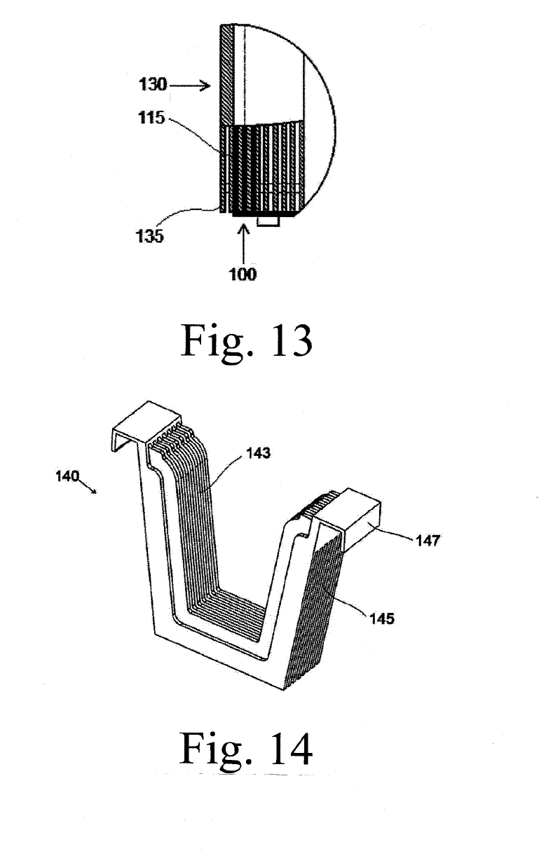

Reference is now made to FIG. 13, presenting a partial cross-sectional view of ribs 115 received by comb-like structure 135. One can see that a degree of positioning freedom of the end member 130 on the 115 ribs is defined by a width of the end member 130.

Reference is now made to FIGS. 14, presenting a perspective view of a two-side comb fitting piece 140 placeable between the ribs and the interconnecting or end members having comb-like structure on opposite sides thereof. Specifically, the two-side comb fitting piece has an upper comb-like structure 143, a lower comb-like structure 145 and grips 147. The pieces 140 can also function as interconnecting member.

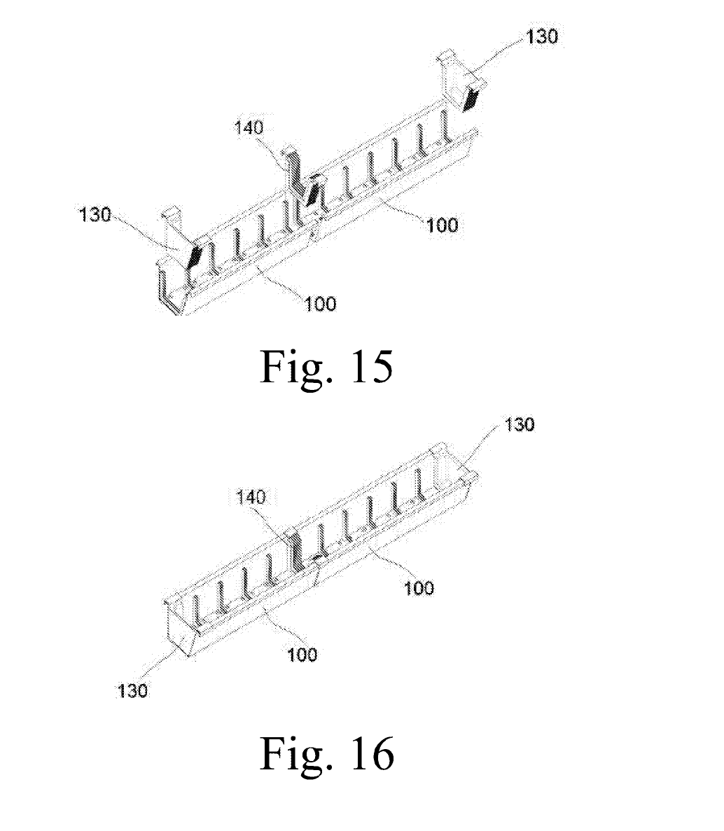

Reference is now made to FIGS. 15 and 16, presenting the set for assembling a length and shape adjustable planter of ribbed surface profile in disassembled and assembled positions. Specifically, troughs 100 can be interconnected the two-side comb fitting piece 140. Open ends of the troughs 100 can be closed by end members 130. As seen in FIG. 16, the fitting piece 140 is partially inserted into one trough 100 and partially into another trough 100 such that a pair of the troughs 100 is interconnected.

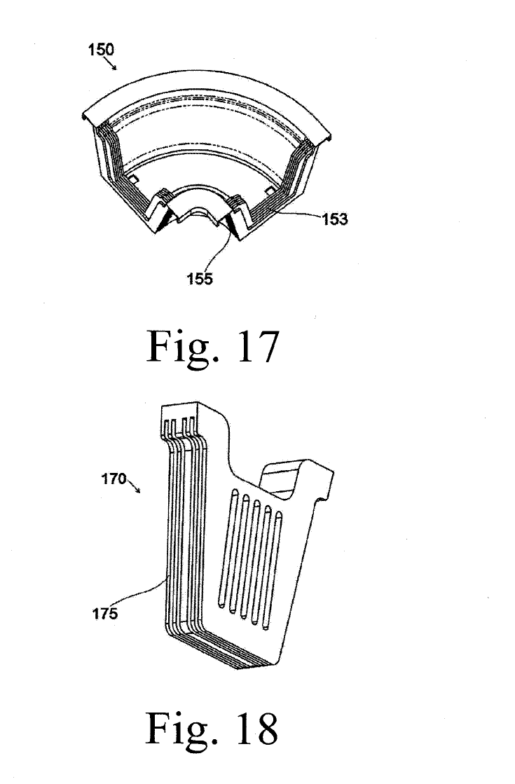

Reference is now made to FIG. 17 presenting a perspective view of an articulation member 150 provided with an upper rib structures 153 and a lower rib structures 155. The upper rib structures can be used for securing the interconnecting members 170 (not shown). The lower rib structures can be set in the end rib structure of the planter through 100 (not shown).

Reference is now made to FIG. 18, presenting an interconnecting member 170 provided with a comb-like structure 175 configured for receiving rib structures thereinto.

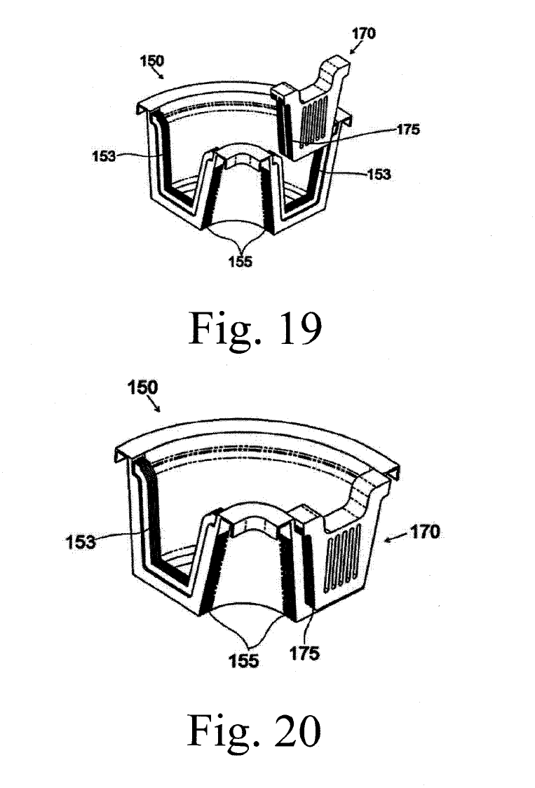

Reference is now made to FIGS. 19 and 20, presenting the articulation member 150 and interconnecting member 170 of ribbed surface profile in disassembled and assembled positions. The comb-like structure 175 of the interconnecting member 170 is partially secured on the rib structure 153. The rest of the comb-like structure 175 is securable on the end rib structure 145 of the fitting piece member 140(not shown).

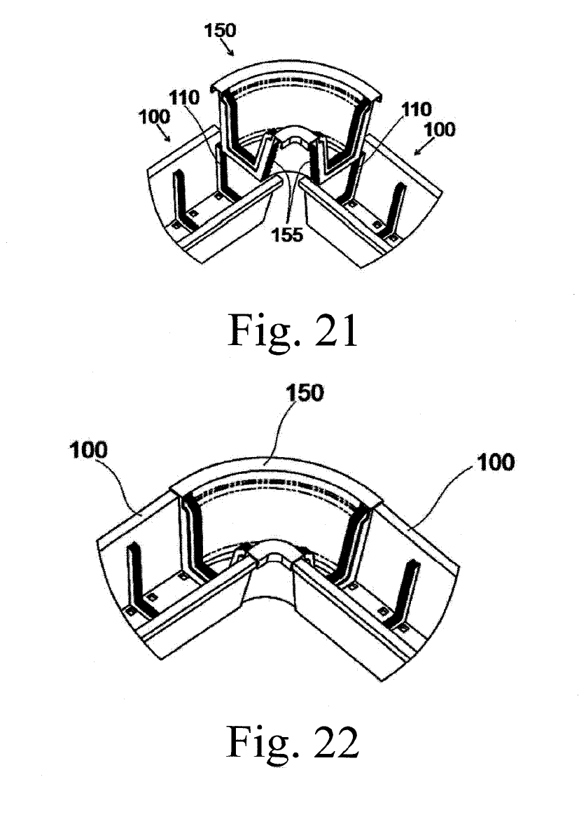

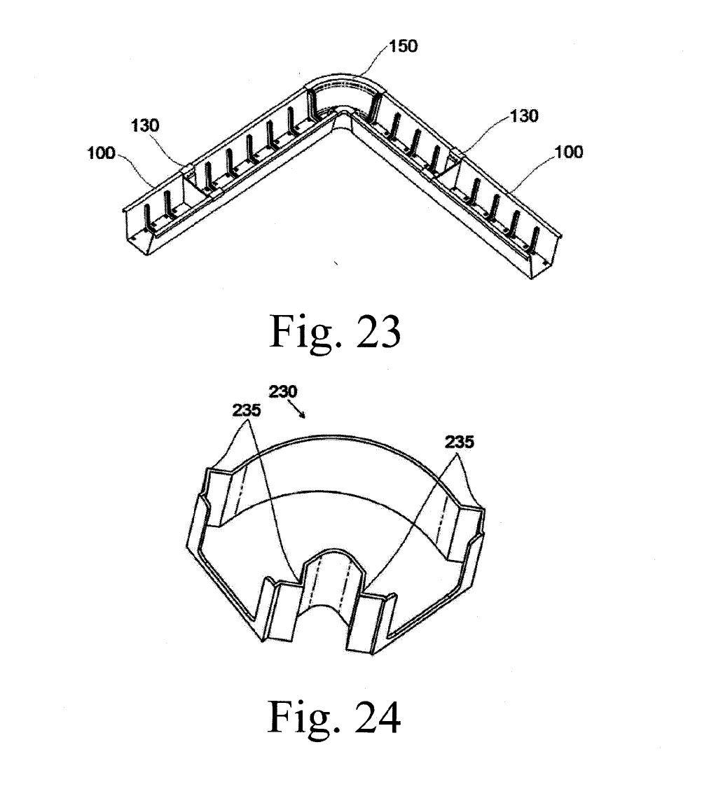

Reference is now made to FIGS. 21, 22 and 23, presenting a pair of ribbed planter troughs 100 interconnectable by the articulation member 150 in disassembled and assembled positions. Specifically, the rib structure 110 is received by the comb-like structure 150 thereinto. In FIG. 23, the end members 130 are secured on the rib structures 110.

Reference is now made to FIG. 24, presenting a perspective view of an articulation member 230 provided with side triangular surface profile structures 235 which are securable on corresponding profiles of the troughs 200 (not shown).

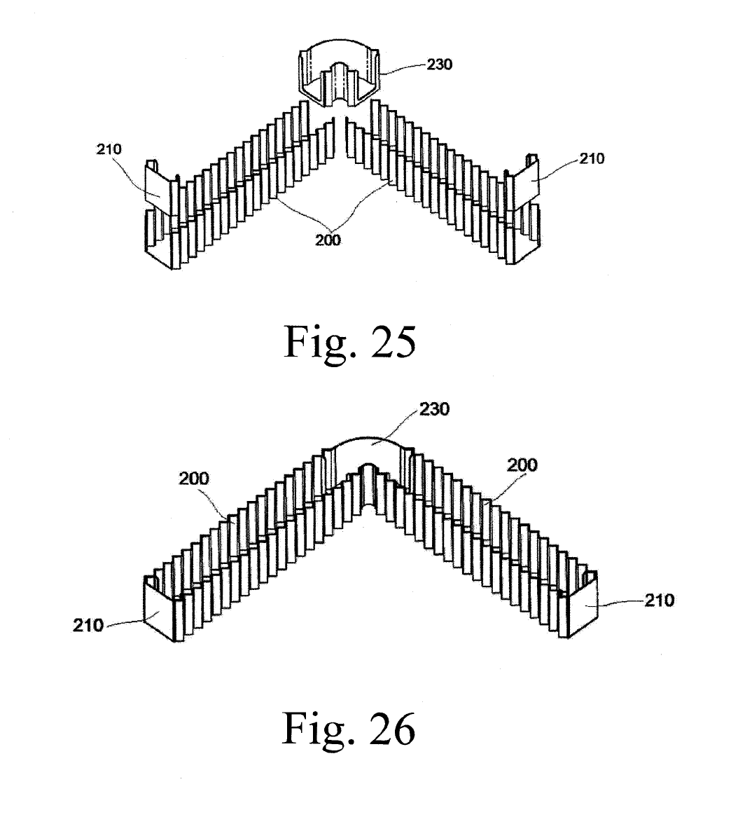

Reference is now made to FIGS. 25 and 26, presenting a pair of triangular surface profile planter troughs 200 interconnectable by the articulation member 230 in disassembled and assembled positions. Specifically, the triangular surface profile structures 235 are tightly secured on the corresponding profile of the planter troughs 200.

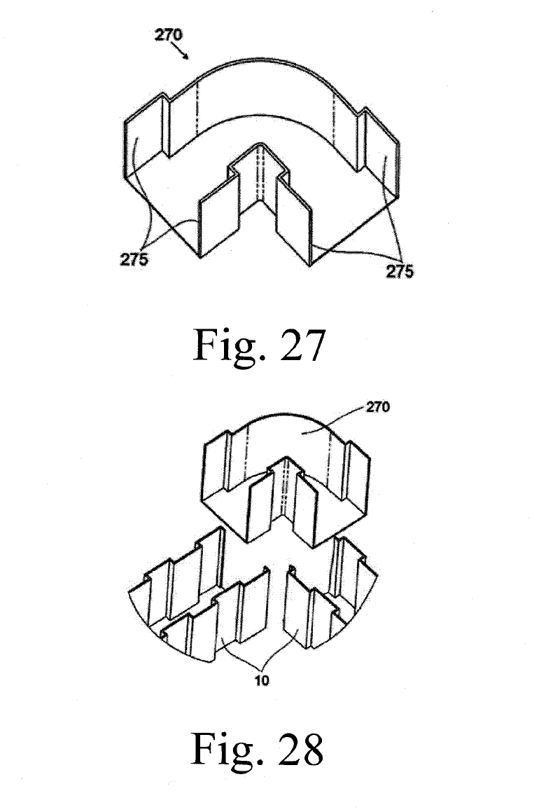

Reference is now made to FIG. 27, presenting a perspective view of an articulation member 270 provided with side faces 275 which are insertable into corresponding profiles of the troughs 10 (not shown).

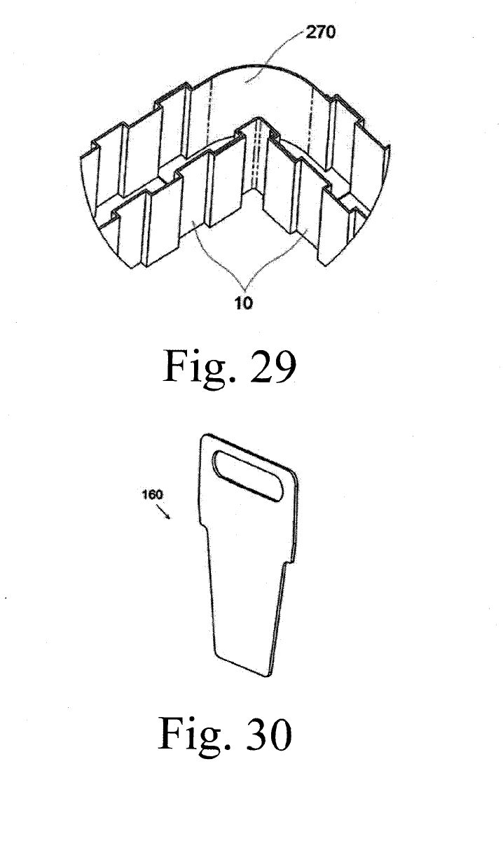

Reference is now made to FIGS. 28 and 29, presenting a pair of rectangular surface profile planter troughs 10 interconnectable by the articulation member 270 in disassembled and assembled positions.

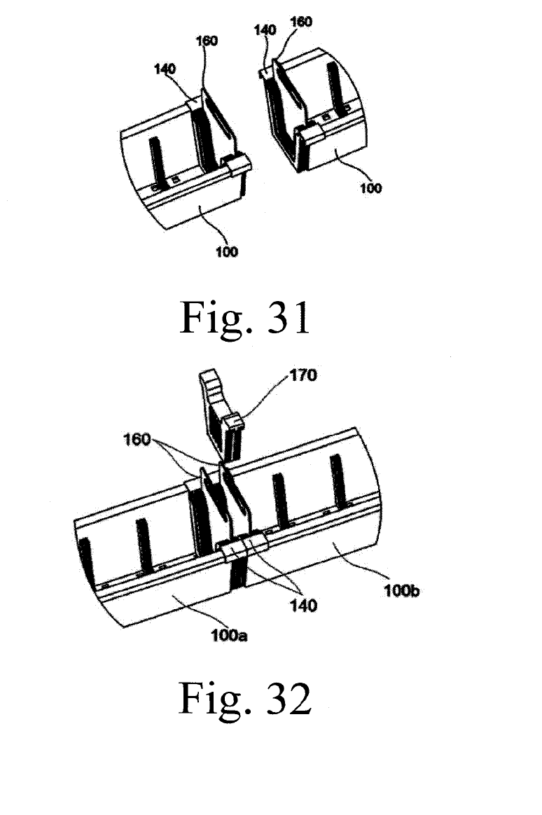

Reference is now made to FIGS. 30 and 31, presenting an edge stopper 160 insertable into two-side comb fitting pieces 140 secured at end portions of troughs 100. According to the present invention, the troughs when loaded with a growing medium (not shown) and, optionally, plants are provided with edge stoppers 160 inserted into the upper comb-like structure of said double-comb fitting piece 140 while the below comb-like structure is secured to the rib structure (not shown) of the trough 100 to prevent trough content (not shown) from pouring out during conveying or assembling.

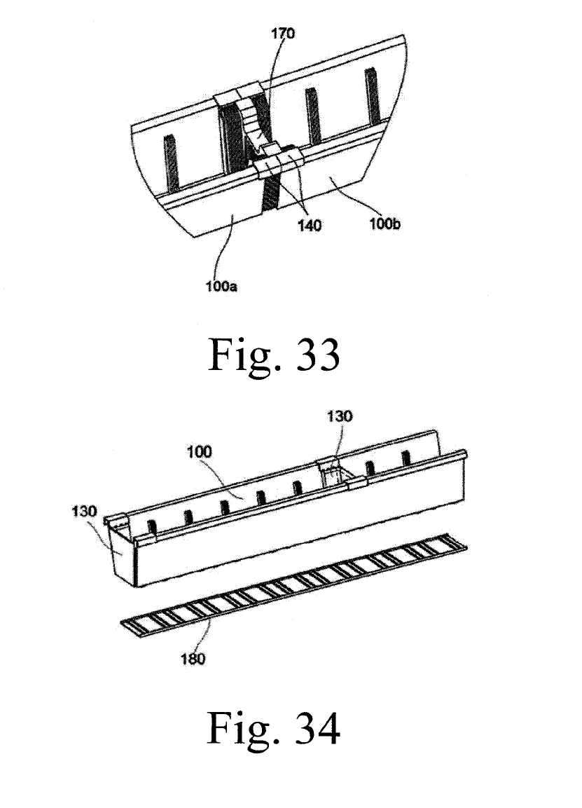

Reference is now made to FIGS. 32 and 33, presenting perspective views of an interconnecting member 170 and two interconnected planter troughs 100. The interconnecting member 170 is provided with a comb-like structure 175. The interconnecting member 170 is insertable partially into the two-side comb fitting piece 140 secured at an end portion of the trough 100A and partially into the two-side comb fitting piece 140 secured at an end portion of the trough 100B in a bridge-like manner.

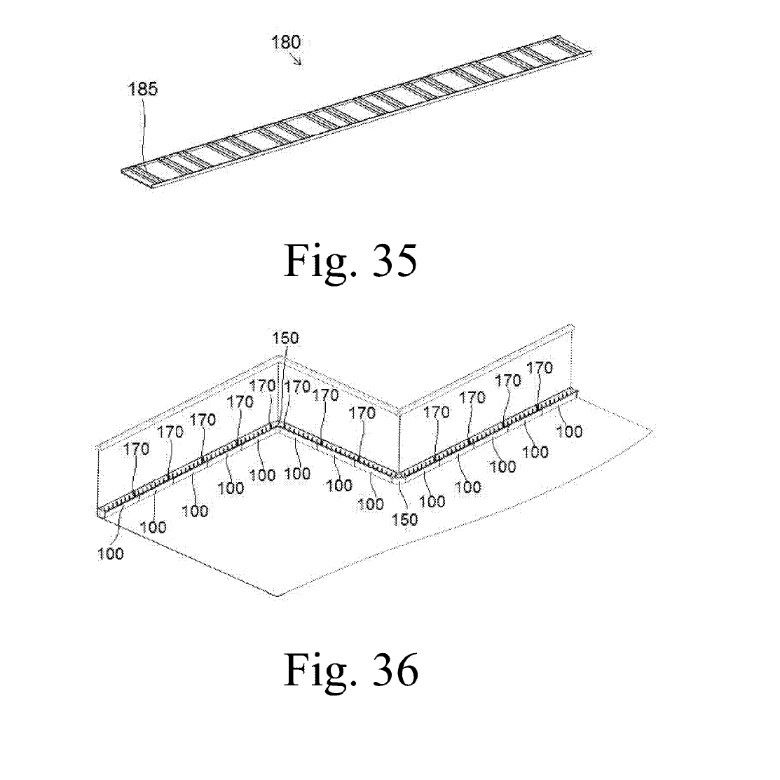

Reference is now made to FIGS. 34 and 35, presenting perspective views of planter trough 100 provided with a water-collecting sump 180 which is length customizable by cutting thereof. According to one embodiment of the present invention, the water-collecting sump 180 has reinforcement ribs 185.

Reference is now made to FIG. 36, presenting an exemplary embodiment of the present invention. Specifically, the planter troughs 100 are interconnected by the interconnected members 170. Where it is necessary to change a direction of the planter trough 100 to be connected to, the articulation members 150 are used.

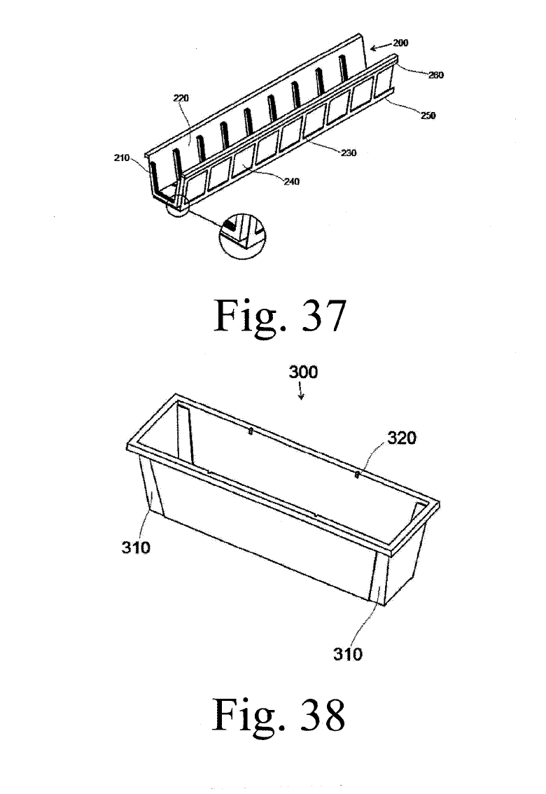

Reference is now made to FIG. 37 presenting an alternative embodiment of a planter trough 200 provided with a water-collecting sump as an integral portion thereof. The planter 200 has an internal shell 210 and an outer shell 220 and can be made from a sheet material by mean of bending thereof. Numerals 250 and 260 refer to bending lines of the sheet material. Cuts 240 are designed for evaporation of the water collected in a lower portion of shell 220.

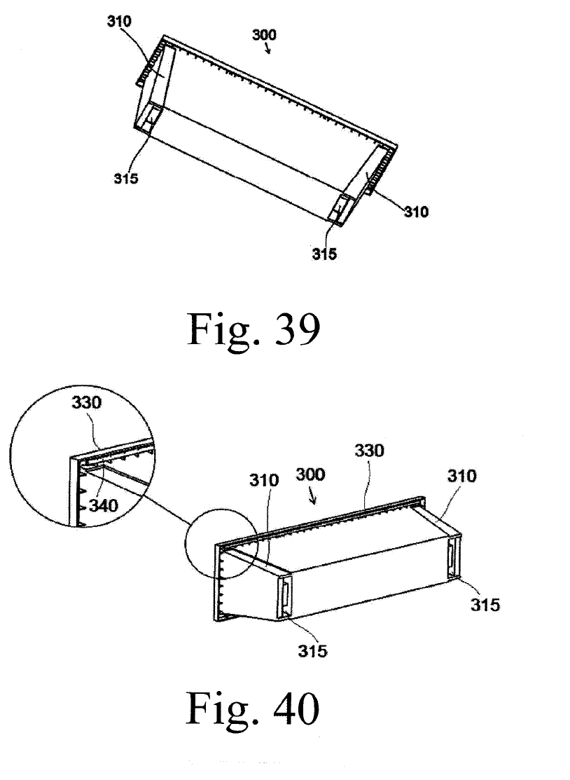

Reference is now made to FIGS. 38 and 39 presenting top and bottom perspective views of close trough 300. The aforesaid trough 300 has daps 310 and slots 315 on both sides.

Reference is now made to FIG. 40 presenting a perspective view of closed planter trough 300 provided with irrigation pipe 340. The aforesaid irrigation pipe 340 is disposed under rim 330. Water from irrigation pipe 340 is dispensed through dispensing openings 320 (see FIG. 38).

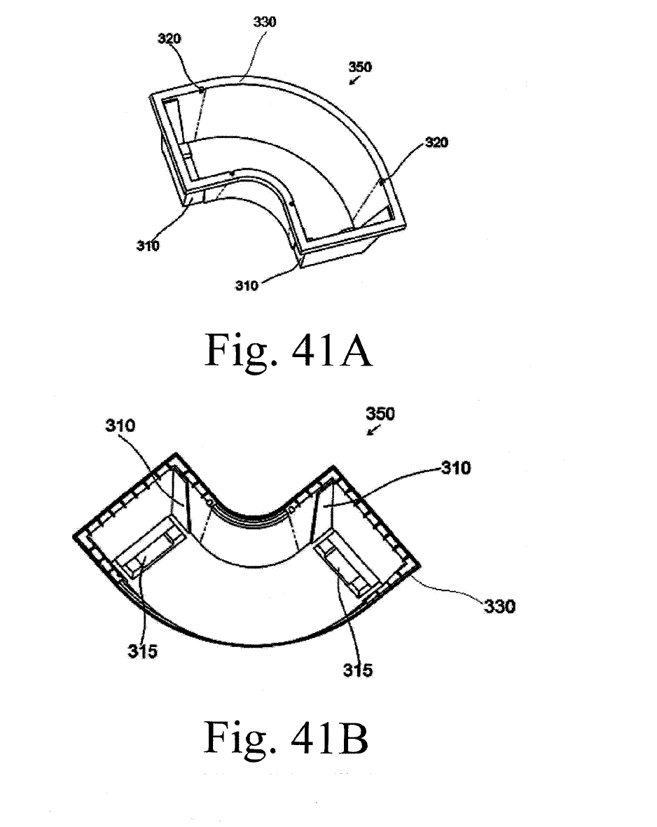

Reference is now made to FIGS. 41A and 41B presenting top and bottom perspective views of corner articulation member 350. Similar to troughs 300, corner articulation member 350 has daps 310 and slots 315 on both sides and rim 330 and 320 for the irrigation system.

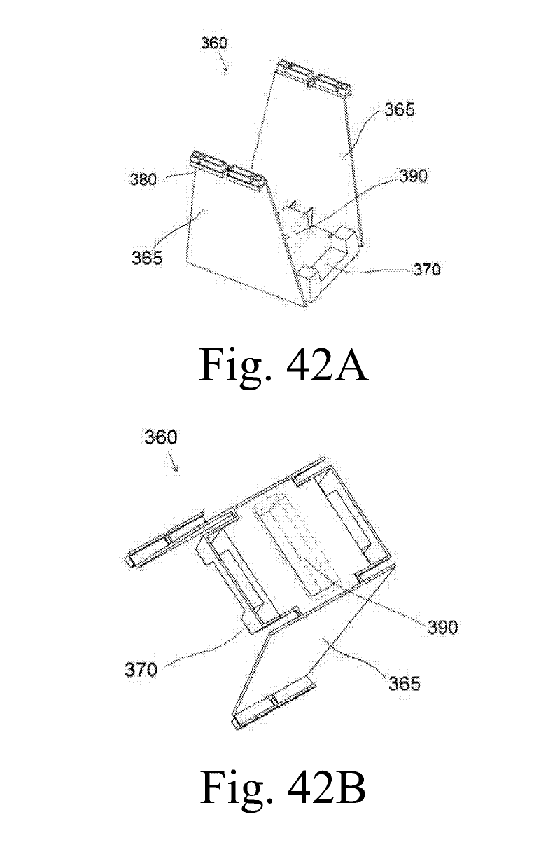

Reference is now made to FIGS. 42A and 42B presenting top and bottom perspective views of straight interconnecting member 360. The latter is configured for connecting to close trough 300 or corner articulation member 350. Specifically, side walls 365 are put onto daps 310, while protrusions 370 are inserted into slots 315. Numeral 380 refers to means for connecting rim portion 330 of close trough 300 or corner articulation member 350.

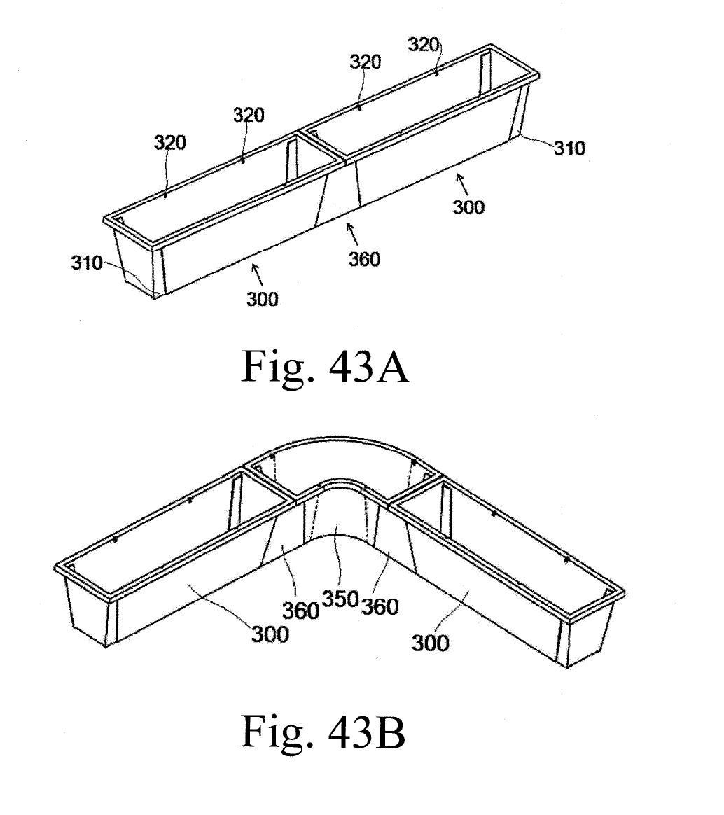

Reference is now made to FIGS. 43A and 43B presenting perspective views of exemplar linear and F-shaped multi-trough planters. Specifically, in FIG. 43A, two close troughs 300 are linearly interconnected by means of straight interconnecting member 360. In FIG. 43B, the linear configuration is converted into the F-shaped one. The assembly depicted in FIG. 43B included corner articulation member 350, which is connected to close troughs 300 by means straight interconnecting member 360.

Any configuration of articles 300, 350 and 360 are in the scope of the present invention. Irrigation pipe 340 can be mounted under rim portions 330 throughout the length of the obtained planter or by any other equivalent manner. The latter is true for any configuration including any trough or articulation members disclosed in the present invention.

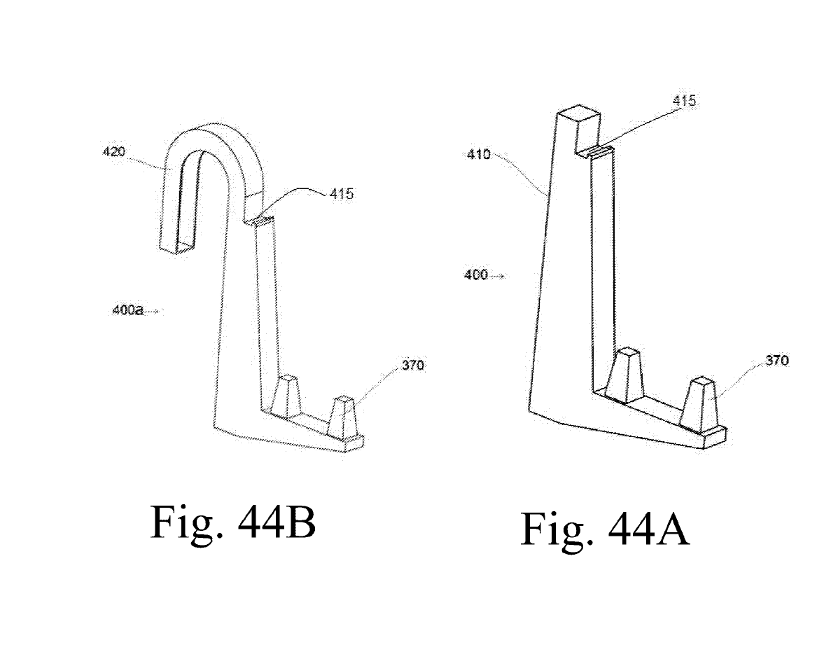

Reference is now made to FIGS. 44A and 44B presenting perspective views of supporting arms connectable to a wall and a rail, respectively. FIG. 44A shows supporting arm 400 configured for securing to a wall of interest. Surface 410 is attachable the wall of interest by any generic technology. Close troughs 300 (not shown) is mountable such that protrusions 370 are inserted into slots 315 and rim sits within groove 415. FIG. 44B depicts supporting arm 400a configured for suspending close troughs 300 on a rail (not shown). Hook 420 is mounted onto the aforesaid rail.

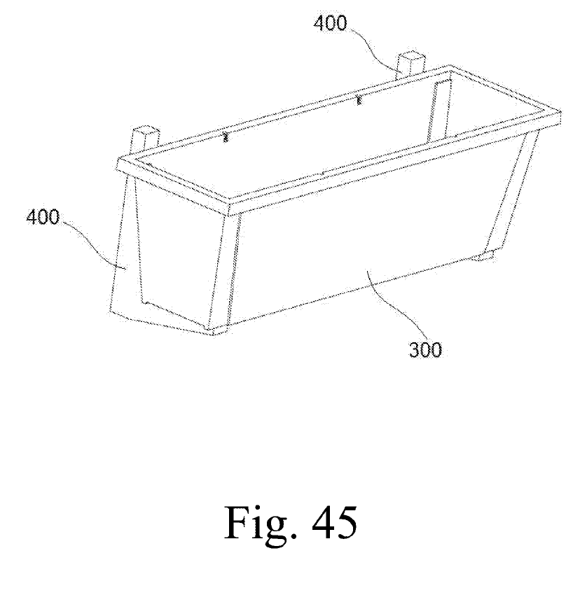

Reference is now made to FIGS. 45 presenting a closed planter trough secured to a wall of interest (not shown). Closed trough 300 is supported by supporting arm 400.

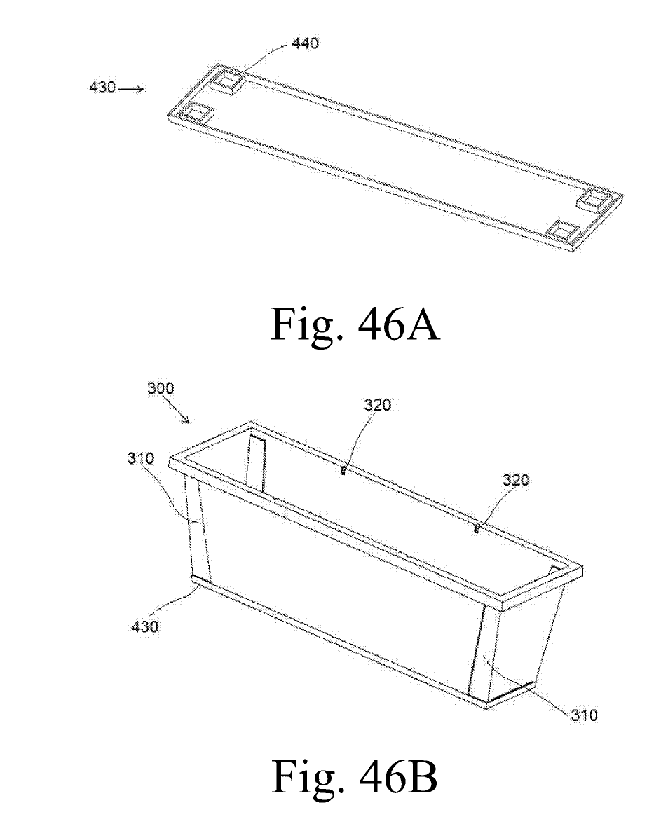

Reference is now made to FIGS. 46A and 46B presenting perspective views of linear water-collecting sump 430 and closed trough 300 standing on water-collecting sump 430. Numeral 440 refers to spacers supporting closed trough 300 standing on the latter.

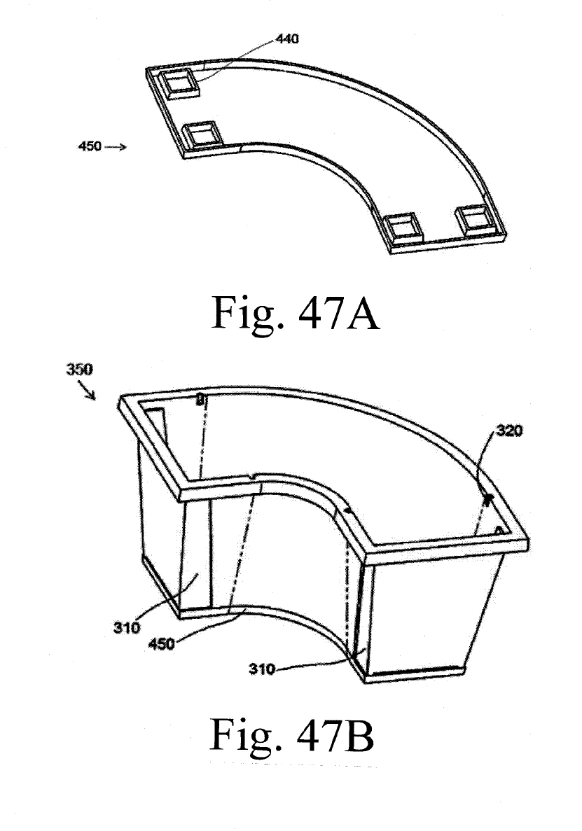

Reference is now made to FIGS. 47A and 47B presenting perspective views of corner water-collecting sump 450 and corner articulation member 350 standing on water-collecting sump 450. Numeral 440 refers to spacers supporting 350 standing on the latter.

In accordance with the present invention, a set for assembling a length and shape adjustable planter is disclosed. The aforesaid set comprises (a) plurality of elongate troughs being length customizable by cutting thereof; the elongate troughs having a longitudinal axis and a H-inverted cross section; the elongate troughs interconnectable therebetween; and (b) interconnecting members configured for interconnecting the elongate troughs in series.

It is a core feature of the invention to provide a surface of each trough at least partially is provided with a surface profile distributed over a length of the trough. The interconnecting members are securable on the surface profile.

In accordance with another embodiment of the present invention, the troughs of the plurality are configured in a shape selected from a group consisting of a H-inverted profile with open ends, a H-inverted profile with closed ends, a H-inverted profile having open and closed ends and any combination thereof.

In accordance with a further embodiment of the present invention, the set comprises end members configured for mounting onto a free end of said elongate troughs.

In accordance with a further embodiment of the present invention, the surface profile is selected from the group consisting of a polygon surface profile, a sinusoidal profile and a comb-like profile including a skewed comb-like surface profile.

In accordance with a further embodiment of the present invention, the polygon profile is selected from the group consisting of a rectangular surface profile and a triangular surface profile including a saw-tooth surface profile.

In accordance with a further embodiment of the present invention, the surface profile is formed by ribs projecting into an internal space of the trough. Each of the interconnecting and end members has a comb-like structure conformably configured for receiving the projecting ribs to be secured on the end fixating structures.

In accordance with a further embodiment of the present invention, the set comprises a plurality of two-side comb fitting pieces placeable between the ribs and the interconnecting or end members having comb-like structure on opposite sides thereof.

In accordance with a further embodiment of the present invention, a lower side of said double-side comb fitting piece which is partially secured to said ribs located at a first elongated trough to be interconnected and partially is secured to said ribs located at a second elongated trough to be interconnected,

In accordance with a further embodiment of the present invention, the set comprises a plurality of edge stoppers configured for inserting into the second comb-like structure of the double-comb fitting piece secured to the end structure of the elongated trough to prevent trough content from pouring out during conveying or assembling.

In accordance with a further embodiment of the present invention, the set comprises at least one articulation member configured for interconnecting the elongate troughs at a customizable angle.

In accordance with a further embodiment of the present invention, the articulation member comprises end surface profile structures for connecting to said troughs and a central portion made of a flexible material.

In accordance with a further embodiment of the present invention, the flexible material is selected from the group consisting of a polymer film, a metal foil, a woven fabric, a non-woven fabric and any combination thereof.

In accordance with a further embodiment of the present invention, the end members are configured for inserting the end members into the double-comb fitting pieces secured to the fixating structures.

In accordance with a further embodiment of the present invention, the set comprises a water-collecting sump which is length customizable by cutting thereof.

In accordance with a further embodiment of the present invention, the sump is provided with at least one reinforcement rib. In accordance with a further embodiment of the present invention, the planter trough is provided with a water-collecting sump as an integral portion thereof.

In accordance with a further embodiment of the present invention, the planter has an internal shell and an outer shell made from a sheet material by mean of bending thereof.

In accordance with a further embodiment of the present invention, the outer shell is provided with at least one cut for evaporation of the water collected in a lower portion of the outer shell.

In accordance with a further embodiment of the present invention, the trough comprises a water pipe connectable to an irrigation device preprogrammed for feeding water/fertilizer solutions to plants to be contained within the troughs.

In accordance with a further embodiment of the present invention, the water pipe has openings for dispensing the water/fertilizer solutions into the troughs.

In accordance with a further embodiment of the present invention, at least one interconnecting member comprises a surface connectable to a vertical wall of interest such that said troughs supported by said interconnecting members are suspendable on said wall.

In accordance with a further embodiment of the present invention, at least one supporting member comprises a hook for suspending said troughs on a rail.

In accordance with a further embodiment of the present invention, a method of assembling a length and shape adjustable planter is disclosed. The aforesaid method comprising the steps of (a) providing a the set comprising (i) a plurality of elongate troughs being length customizable by cutting thereof; the elongate troughs having a longitudinal axis and a H-inverted cross section; the elongate troughs interconnectable therebetween; and (ii) interconnecting members configured for interconnecting the elongate troughs in series; a surface of each trough at least partially is provided with a surface profile perpendicularly oriented to the longitudinal axis; the surface profile are distributed over a length of the trough; the interconnecting members are securable on the surface profile; (b) customizing the length of the troughs by cutting thereof; (c) interconnecting the elongate troughs in series by means the interconnecting members; (d) mounting the end members onto the free ends of the elongate troughs.

In accordance with a further embodiment of the present invention, the step of interconnecting the elongate troughs further comprises securing the interconnecting members on the surface profile.

In accordance with a further embodiment of the present invention, the step of securing the interconnecting members is performed on the surface profile formed by ribs projecting into an internal space of the trough. Each of the interconnecting and end members has a comb-like structure conformably configured for receiving the projecting ribs to be secured on the end fixating structures.

In accordance with a further embodiment of the present invention, the method comprises a step of placing a plurality of two-side comb fitting pieces between the ribs and the interconnecting or end members having comb-like structure on opposite sides thereof.

In accordance with a further embodiment of the present invention, the step of placing a plurality of two-side comb fitting pieces comprises securing a lower side of a first double-side comb fitting piece to the ribs located at an portion of a first elongated trough to be interconnected, a lower side of a second double-comb fitting piece to ribs located at an portion of a second elongated trough to be interconnected. The comb-like structure of the interconnecting member is partially received by of an upper side of the first double-side comb fitting piece and partially received by of an upper side of the second double-side comb fitting piece forming a trough interconnection arrangement.

In accordance with a further embodiment of the present invention, the method comprises a step of inserting a plurality of edge stoppers configured into the upper side of the double-side comb fitting piece secured to the end structure of the elongated trough to prevent trough content from pouring out during conveying or assembling.

In accordance with a further embodiment of the present invention, the method comprises a step of interconnecting the elongate troughs by means of at least one articulation member at a predetermined angle.

In accordance with a further embodiment of the present invention, the method comprises a step of irrigating said trough by means of a water pipe connectable to an irrigation device preprogrammed for feeding water/fertilizer solutions to plants to be contained within said troughs.

In accordance with a further embodiment of the present invention, the step of irrigating the trough is performed by means of a water pipe having openings for dispensing the water/fertilizer solutions into the troughs.

In accordance with a further embodiment of the present invention, the set comprises a step of suspending said troughs on a wall of interest by at least one interconnecting member comprising a surface connectable to a vertical wall of interest such that said troughs supported by said interconnecting members are suspendable on said wall.

In accordance with a further embodiment of the present invention, a step of suspending said troughs by means of at least one supporting member comprises a hook for suspending said troughs on a rail.

1-41. (canceled)

42. A set for assembling a length and shape adjustable planter; said set comprising:
a. a plurality of elongate troughs having a longitudinal axis, a H-inverted cross section and closed ends; said elongate troughs interconnectable therebetween; and
b. interconnecting members configured for interconnecting said elongate troughs in series;
wherein a side surface of each trough at least partially is provided with a surface profile distributed over a length of said trough; said elongate troughs and interconnecting members have cooperatively arranged protrusions and slots configured for inserting one to another;
said interconnecting members are securable on said surface profile.

43. The set according to claim 42, wherein at least one of the following is true:
a. said set comprises end members configured for mounting onto said open ends of said elongate troughs;
b. said surface profile is selected from the group consisting of a polygon surface profile, a sinusoidal profile and a comb-like profile including a skewed comb-like surface profile;
c. said set comprises at least one articulation member configured for interconnecting said elongate troughs at a customizable angle;
d. said set comprises a water-collecting sump which is length customizable by cutting thereof;
e. said planter trough has an internal shell and an outer shell made from a sheet material by mean of bending thereof;
f. said planter trough comprises a water pipe connectable to an irrigation device preprogrammed for feeding water/fertilizer solutions to plants to be contained within said troughs;
g. at least one supporting member comprises a surface connectable to a vertical wall of interest such that said troughs supported by said supporting members are suspendable on said wall;
h. at least one supporting member comprises a hook for suspending said troughs on a rail.

44. The set according to claim 43, wherein at least one of the following is true:
a. said polygon profile is selected from the group consisting of a rectangular surface profile and a triangular surface profile including a saw-tooth surface profile; and
b. said surface profile are formed by ribs projecting into an internal space of said trough; each of said interconnecting and end members has said comb-like structure conformably configured for receiving said projecting ribs to be secured on said end fixating structures.

45. The set according to claim 44 comprising a plurality of two-side comb fitting pieces placeable between said ribs and said interconnecting or end members having comb-like structure on opposite sides thereof.

46. The set according to claim 45, wherein a lower side of said double-side comb fitting piece is partially secured to said ribs located at a first elongated trough to be interconnected and partially secured to said ribs located at a second elongated trough to be interconnected.

47. The set according to claim 46 comprising a plurality of edge stoppers configured for inserting into said second comb-like structure of said double-comb fitting piece secured to said end structure of said elongated trough to prevent trough content from pouring out during conveying or assembling.

48. The set according to claim 43, wherein said articulation member comprises end surface profile structures for connecting to said troughs and a central portion made of a flexible material.

49. The set according to claim 48, wherein said flexible material is selected from the group consisting of a polymer film, a metal foil, a woven fabric, a non-woven fabric and any combination thereof.

50. The set according to claim 44, wherein said end members are configured for inserting said end members into said double-comb fitting pieces secured to said fixating structures.

51. The set according to claim 43, wherein said sump provided with at least one reinforcement rib.

52. The set according to claim 43, wherein said planter trough is provided with a water-collecting sump as an integral portion thereof.

53. The set according to claim 43, wherein said outer shell is provided with at least one cut for evaporation of the water collected in a lower portion of said outer shell.

54. The set according to claim 43, wherein said water pipe has openings for dispensing said water/fertilizer solutions into said troughs.

55. A method of assembling a length and shape adjustable planter; said method comprising the steps of:
a. providing a said set comprising:
i. a plurality of elongate troughs; said elongate troughs having a longitudinal, a H-inverted cross section and closed ends; said elongate troughs interconnectable therebetween; and
ii. interconnecting members configured for interconnecting said elongate troughs in series;
a side surface of each trough at least partially is provided with a surface profile perpendicularly oriented to said longitudinal axis; said surface profile are distributed over a length of said trough; said elongate troughs and interconnecting members have cooperatively arranged protrusions and slots configured for inserting one to another; said interconnecting members are securable on said surface profile;
b. interconnecting said elongate troughs in series by means said interconnecting members;
c. mounting said end members onto said free ends of said elongate troughs wherein said step of interconnecting said elongate troughs further comprises securing said interconnecting members on said surface profile.

56. The method according to claim 55, wherein at least one of the following is true:
a. said step of securing said interconnecting members is performed on said surface profile formed by ribs projecting into an internal space of said trough; each of said interconnecting and end members has a comb-like structure conformably configured for receiving said projecting ribs to be secured on said end fixating structures;
b. said method comprises a step of placing a plurality of two-side comb fitting pieces between said ribs and said interconnecting or end members having comb-like structure on opposite sides thereof;
c. said method comprises a step of inserting a plurality of edge stoppers configured into said upper side of said double-side comb fitting piece secured to said end structure of said elongated trough to prevent trough content from pouring out during conveying or assembling;
d. said method comprises a step of interconnecting said elongate troughs by means of at least one articulation member at a customizable angle.

57. The method according to claim 56, wherein said step of placing a plurality of two-side comb fitting pieces comprises securing a lower side of said double-side comb fitting piece partially to said ribs located at a first elongated trough to be interconnected and partially to said ribs located at an portion of a second elongated trough to be interconnected.

58. The method according to claim 56, wherein said articulation member is provided with end surface profile structures for connecting to said troughs and a central portion made of a flexible material.

59. The method according to claim 55, comprising a step of irrigating said trough by means of a water pipe connectable to an irrigation device preprogrammed for feeding water/fertilizer solutions to plants to be contained within said troughs.

60. The set according to claim 59, wherein said step of irrigating said trough is performed by means of a water pipe having openings for dispensing said water/fertilizer solutions into said troughs.

61. The set according to claim 55, comprising at least one of the following:
a. a step of suspending at least one said trough on a wall of interest by at least one supporting member comprising a surface connectable to a vertical wall of interest such that said troughs supported by said interconnecting members are suspendable on said wall; and
b. a step of suspending at least one said trough by at least one supporting member comprising a hook for suspending said troughs on a rail.
